(19) United States
(12) Patent Application Publication
(10) Pub. No.: US 2026/0050585 A1
(43) Pub. Date: Feb. 19, 2026

(54) DETECTING CHANGES IN DATA ASSETS FOR TARGETED GENERATION OF VECTOR EMBEDDINGS

(71) Applicant: View Systems, Inc., Dover, DE (US)

(72) Inventors: Blake Martz, San Diego, CA (US); Keith Barto, Pine, CO (US); Joel Christner, El Dorado Hills, CA (US); Alex Nogle, Carlsbad, CA (US); Yipeng Li, Campbell, CA (US)

(73) Assignee: View Systems, Inc., Dover, DE (US)

(21) Appl. No.: 19/293,528

(22) Filed: Aug. 7, 2025

Related U.S. Application Data
(60) Provisional application No. 63/683,350, filed on Aug. 15, 2024.

(51) Int. Cl. G06F 16/22; G06F 16/23

(52) U.S. Cl. CPC G06F 16/2237; G06F 16/2255; G06F 16/2365

(57) ABSTRACT

This disclosure provides methods, devices, and systems for generating vector embeddings. The present implementations more specifically relate to detecting changes in a data asset for targeted embeddings generation. For example, a data processing pipeline may receive a data asset to be converted to a set of vector embeddings. In some aspects, the data processing pipeline may map the data asset to one or more hash values and compare the hash values to a lookup table. The lookup table stores known hash values associated with previously generated vector embeddings stored in a vector repository. The data processing pipeline selectively maps the data asset to one or more vector embeddings based on whether the hash values match any of the known hash values in the lookup table. More specifically, the data processing pipeline may refrain from generating any new vector embeddings if each of the hash values matches a known hash value.

### CROSS-REFERENCE TO RELATED APPLICATIONS

This application claims priority and benefit under 35 U.S.C. § 119 (c) to U.S. Provisional Patent Application No. 63/683,350, filed Aug. 15, 2024, which is incorporated herein by reference in its entirety.

### TECHNICAL FIELD

This disclosure relates generally to data management in computer systems, and specifically to detecting changes in data assets for targeted generation of vector embeddings.

### DESCRIPTION OF RELATED ART

Many businesses store and use data of various types (including structured data and unstructured data), each having its own layout and semantics configured for the applications and/or users producing or consuming the data. Some businesses may benefit by leveraging such data assets as a means of yielding business insights (such as analytics) or creating transformative experiences, such as those provided through machine learning. Machine learning (also referred to as “artificial intelligence” or “AI”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.” Example suitable neural networks include convolutional neural networks (CNNs), recurrent neural networks (RNNs), long short-term memory (LSTM) networks, and transformers, among other examples.

Many neural networks are designed to process vectorized data, also referred to as “embeddings.” An embedding is a numerical vector, in any high-dimensional space, having a magnitude and direction that represents a real-world object (such as a word) or set of objects (such as a sentence, paragraph, or other grouping of words). The mapping between objects and embeddings is defined by the neural network model used to process the embeddings. In other words, different neural network models may map the same object to different vector embeddings (which may reside in different multidimensional spaces). However, the process of generating embeddings is computationally intensive and time consuming, which can be cost-prohibitive for some businesses and create material delays in the data processing pipelines for AI applications. Thus, there is a need to reduce the overhead (such as time and resource requirements) associated with vectorizing data for neural network processing.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for processing data. The method includes steps of receiving a data asset; mapping the data asset to one or more hash values; determining whether the one or more hash values match one or more known hash values stored in a lookup table; and selectively mapping the data asset to one or more vector embeddings based on whether the one or more hash values match the one or more known hash values.

Another innovative aspect of the subject matter of this disclosure can be implemented in a data processing pipeline, including a processing system and a memory. The memory stores instructions that, when executed by the processing system, cause the data processing pipeline to receive a data asset; map the data asset to one or more hash values; determine whether the one or more hash values match one or more known hash values stored in a lookup table; and selectively map the data asset to one or more vector embeddings based on whether the one or more hash values match the one or more known hash values.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows a block diagram of an example data processing pipeline, according to some implementations.

FIG. 3A shows an example data asset.

FIG. 3B shows example metadata that can be extracted from the data asset of FIG. 3A, according to some implementations.

FIG. 4A shows another example data asset.

FIG. 4B shows example metadata that can be extracted from the data asset of FIG. 4A, according to some implementations.

FIG. 5 shows a block diagram of an example data processing pipeline, according to some implementations.

FIG. 6 shows an illustrative flowchart depicting an example operation for processing data, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

As described above, “embeddings” are numerical vectors representing real-world objects (such as words) or sets of objects (such as sentences, paragraphs, or other groupings of words) that can be provided as inputs to neural networks for training and inferencing purposes. More specifically, a data asset (such as a slideshow presentation, word processing document, or structured query language (SQL) database) must be converted or “mapped” to a set of embeddings before it can be processed through the layers of a neural network. Thus, the terms “embedding” and “vector embedding” may be used herein interchangeably. For many AI applications (such as retrieval augmented generation (RAG)), the data asset being processed by the neural network is often an updated or revised version of another data asset previously processed by the same neural network (such as an updated draft of the same document or file). Existing AI data processing pipelines are designed to generate embeddings for each new data asset, in its entirety, even if only a portion of the data asset has changed from a previous version of the data asset. Aspects of the present disclosure recognize that the overhead associated with generating embeddings can be significantly reduced by reusing embeddings for portions of a data asset that remain unchanged from previous versions of the data asset.

Various aspects relate generally to systems and techniques for generating vector embeddings, and more particularly, to detecting changes in a data asset for targeted embeddings generation. For example, a data processing pipeline may receive a data asset to be converted to a set of vector embeddings. In some aspects, the data processing pipeline may map the data asset to one or more hash values and compare the hash values to a lookup table. The lookup table stores known hash values associated with previously generated vector embeddings stored in a vector repository. The data processing pipeline selectively maps the data asset to one or more vector embeddings based on whether the hash values match any of the known hash values in the lookup table. Specifically, the data processing pipeline may refrain from generating any new vector embeddings if each of the hash values matches a known hash value in the lookup table. In some implementations, the data processing pipeline may subdivide the data asset into multiple data segments (such as semantic cells and/or chunks), where each of the data segments is mapped to a respective hash value. In such implementations, the data processing pipeline may generate a new vector embedding for each of the data segments only if the hash value associated with the data segment does not match any of the known hash values in the lookup table.

Particular implementations of the subject matter described in this disclosure can be implemented to realize one or more of the following potential advantages. By mapping each data asset to one or more hash values and comparing them to known hash values associated with previously generated embeddings, aspects of the present disclosure can quickly detect changes or updates to the data asset that may require the generation of new embeddings. More specifically, the data processing pipeline of the present implementations can avoid generating redundant embeddings for data assets (or portions thereof) that remain unchanged from previous versions of the same data assets. For example, if the hash values associated with a new data asset match known hash values associated with previously generated embeddings, the data processing pipeline may retrieve and/or reuse such previous embeddings in the vector database rather than generate new embeddings for the new data asset. By subdividing each data asset into multiple data segments and mapping each data segment to a respective hash value, aspects of the present disclosure can perform such targeted generation of embeddings at even finer granularities. For example, the data processing pipeline of the present implementations can generate embeddings for any chunks of the data asset that are new or different while reusing previously generated embeddings for any chunks of the data asset that remain unchanged from previous versions of the same data asset.

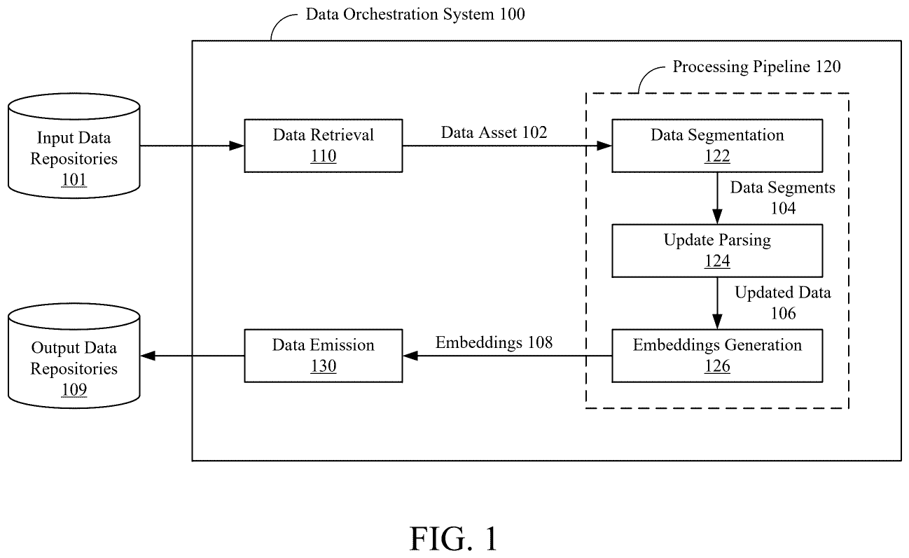

FIG. 1 shows a block diagram of an example data orchestration system 100, according to some implementations. The data orchestration system 100 is configured to retrieve data assets 102 from one or more input data repositories 101, convert each data asset 102 to a respective set of embeddings 108, and emit the resulting embeddings 108 to one or more output data repositories 109. A data asset 102 can be a document, file, or database of any type (such as images, videos, slideshow presentations, word processing documents, SQL databases, JavaScript Object Notation (JSON) files, and HyperText Markup Language (HTML) documents, among other examples). In some implementations, the output data repositories 109 may be different than the input data repositories 101. In some other implementations, the output data repositories 109 may be the same as the input data repositories 101.

The data orchestration system 100 includes a data retrieval component 110, a data processing pipeline 120, and a data emission component 130. The data retrieval component 110 is configured to communicate or interface with the input data repositories 101 to facilitate the retrieval of data assets 102. Example suitable input data repositories 101 include computers, servers, storage systems, and third-party platforms (such as software-as-a-service (SaaS) platforms), among other examples. In some implementations, the data retrieval component 110 may store information identifying the one or more input data repositories 101 from which the data assets 102 can be retrieved. In some implementations, the data retrieval component 110 may detect or identify the input data repositories 101 using network discovery tools (such as by querying Active Directory or performing port scans on the network).

The data emission component 130 is configured to communicate or interface with the output data repositories 109 to facilitate the storage or emission of the embeddings 108. Example suitable output data repositories 109 include computers, servers, storage systems, and/or third-party platforms that are connected or otherwise accessible to processing systems and/or applications configured to use or perform additional processing on the embeddings 108 (such as for analytics or machine learning). In some implementations, the data emission component 130 may store information identifying the one or more output data repositories 109 to which the embeddings 108 can be emitted and/or stored.

The data processing pipeline 120 is configured to perform a number of data operations that transform the data asset 102 into the embeddings 108. More specifically, the data processing pipeline 120 may process the data asset 102 according to one or more data objectives and/or requirements of a processing system or application (such as a machine learning model) intended to consume the data asset 102. In some implementations, the data processing pipeline 120 may store a set of discrete data operations that can be used to construct a data flow. A data flow defines the order in which the data operations are performed, including which specific steps are taken given a successful step, a failed step, or a step that encounters an unrecoverable exception. The data operations may include open-source and/or closed-source libraries that are configured to perform discrete tasks against the data. Example suitable tasks include loading data from a file or database, extracting text, stemming or lemmatizing the text, and merging it the data, among other examples.

In the example of FIG. 1, the data processing pipeline 120 is shown to include at least a data segmentation component 122, an update parsing component 124, and an embeddings generation component 126. The data segmentation component 122 is configured to subdivide the data asset 102 into one or more data segments 104. In some implementations, the data segmentation component 122 may balance the granularity of the data segments 104 with the resource limitations of the data processing pipeline 120 and/or with the data objectives or requirements of the processing system or application intended to consume the data asset 102. For example, subdividing the data asset 102 into more data segments 104 of finer granularity may require more processing resources of the data processing pipeline 120 than subdividing the data asset 102 into fewer data segments 104 of coarser granularity.

The update parsing component 124 is configured to parse the data segments 104 for changes or updates compared to other data segments previously processed by the data processing pipeline 120 (also referred to as “previous data segments”). For example, the update parsing component 124 may compare each of the data segments 104 to a database of previous data segments and/or information associated therewith. In some implementations, the database may be a lookup table (LUT) that stores hash values associated with the previous data segments (in addition to, or in lieu of, the previous data segments). In such implementations, the update parsing component 124 may map each of the data segments 104 to a respective hash value based on a hash function associated with the LUT. Example suitable hash functions include Message-Digest Algorithm 5 (MD5), Secure Hash Algorithm 1 (SHA-1), and Secure Hash Algorithm 256-bit (SHA-256), among other examples. In some implementations, the update parsing component 125 may output each data segment 104, as updated data 106, only if the data segment 104 (or its hash value) does not match any of the previous data segments (or their associated hash values).

The embeddings generation component 126 is configured to generate the embeddings 108 based on the updated data 106. As described above, an embedding is a mapping of any discrete (or categorical) variable to a vector of continuous numbers (such as a floating-point number) in a high-dimensional space. Thus, the process of generating embeddings is computationally intensive and time consuming. In some implementations, the embeddings generation component 126 may store embeddings for previous data segments in a vector repository (such as one of the output data repositories 109) and may generate new embeddings 108 only for the updated data 106. More specifically, the embeddings generation component 126 may reuse embeddings from the vector repository for data segments 104 that have not been changed or updated. For example, the embeddings generation component 126 may match any unchanged data segments 104 to existing embeddings in the vector repository (rather than map such data segments 104 to new embeddings 108). In some implementations, the embeddings generation component 126 may further store the new embeddings 108 in the vector repository.

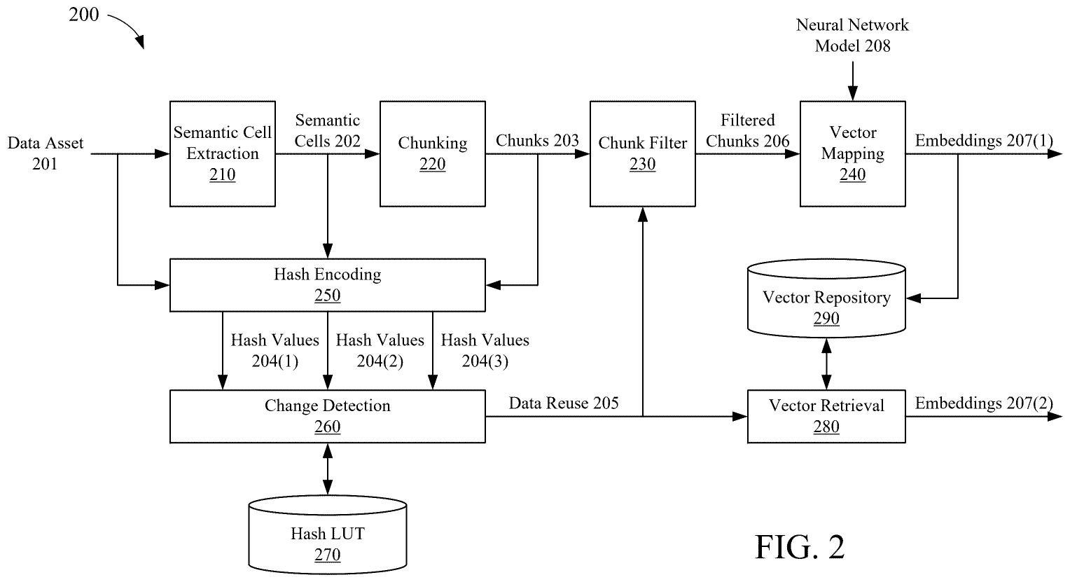

FIG. 2 shows a block diagram of an example data processing pipeline 200, according to some implementations. In some implementations, the data processing pipeline 200 may be one example of the data processing pipeline 120 of FIG. 1. More specifically, the data processing pipeline 200 is configured to transform a data asset 201 into a set of embeddings 207(1)-207(2). With reference to FIG. 1, the data asset 201 may be one example of the data asset 102. In some implementations, the embeddings 207(1)-207(2) may be associated with a neural network model 208. In other words, the data processing pipeline 200 is configured to prepare the data asset 201 to be processed or consumed by the neural network model 208.

Aspects of the present disclosure recognize that neural network models (including natural language processing (NLP) models and large language models (LLMs)) have predefined dimensionalities. In other words, a neural network model can only process and/or generate vector embeddings having a fixed size or dimension. As a result, the amount of input data represented by each vector embedding affects the fidelity of the neural network model. For example, mapping more input data to each vector embedding improves the efficiency of the training and/or inferencing operations but reduces the fidelity of the results. On the other hand, mapping less input data to each vector embedding sacrifices efficiency of the training and/or inferencing operations to improve the fidelity of the results. Thus, in some implementations, the data processing pipeline 200 may subdivide the data asset 201 into one or more data segments (such as the data segments 104 of FIG. 1) having a predetermined granularity based, at least in part, on the dimensionality of the neural network model 208. More specifically, the granularity of the data segments may balance the efficiency of the training and/or inferencing operations with the fidelity of the neural network model 208.

The data processing pipeline 200 includes a semantic cell extraction component 210, a chunking component 220, a chunk filter 230, a vector mapping component 240, a hash encoding component 250, a change detection component 260, and a vector retrieval component 280. The semantic cell extraction component 210 is configured to parse or arrange the data in the data asset 201 into one or more semantic cells 202. As used herein, the term “semantic cell” refers to a grouping of data that is semantically related. Example suitable semantic cells include sentences, paragraphs, pictures, and/or slides. A semantic cell can also be a “child” of another semantic cell (such as a sentence within a paragraph). The chunking component 220 is configured to arrange the data within each semantic cell 202 into even more granular chunks 203. As used herein, the term “chunk” refers to a subgrouping of data that is related to a given semantic cell. For example, chunks may be used to break down a semantic cell into smaller groups of data that can be processed more efficiently by a machine or computer (such as an LLM or NLP model) or yield more accurate and/or precise results.

The hash encoding component 250 is configured to map the data asset 201, the semantic cells 202, and the chunks 203 to hash values 204(1)-204(3) based on one or more hash functions. Example suitable hash functions include MD5, SHA-1, and SHA-256, among other examples. In some implementations, the hash encoding component 250 may generate and/or arrange the hash values 204(1)-204(3) in a hierarchical manner, so that the data asset 201 is mapped to a single hash value 204 (1) at a top level of the hierarchy, the semantic cells 202 are mapped to respective hash values 204(2) in a middle level of the hierarchy, and the data chunks 203 are mapped to respective hash values 204(3) at a bottom level of the hierarchy. In some implementations, the hash encoding component 240 may use the same hash function to generate each of the hash values 204(1)-204(3). In some other implementations, the hash encoding component 240 may use different hash functions to generate different hash values 204 (1), 204(2), and/or 204(3). For example, the hash value 204 (1) may be associated with a first hash function, the hash values 204(2) may be associated with a second hash function, and the hash values 204(3) may be associated with a third hash function.

Still further, in some implementations, the hash encoding component 240 may use multiple hash functions to generate the hash values 204(1)-204(3). For example, the hash encoding component 240 may map the data asset 201 to multiple hash values 204 (1) each associated with a different hash function (such as a combination of MD5, SHA-1, and/or SHA-256). Generating multiple hash values associated with different hash functions adds redundancy for detecting changes to the data asset 201, the semantic cells 202, and/or the data chunks 203 (so that the data processing pipeline 200 can detect duplicate or redundant data with greater certainty), while also providing greater flexibility for optimizing the performance of the data processing pipeline 200. For example, the data processing pipeline 200 may be programmed or otherwise instructed to use the hash values associated with a given hash function based on whether speed (MD5) or accuracy (SHA-256) is more important for the data objectives of the data processing pipeline 200 at any given time.

The change detection component 260 is configured to compare the hash values 204(1)-204(3) to a hash lookup table (LUT) 270 to determine which (if any) of the data chunks 203 match previously generated vector embeddings that can be reused by the data processing pipeline 200. For example, the hash LUT 270 may store a number of “known” hash values that were previously generated by the data processing pipeline 200 (such as for previously processed data assets 201). Accordingly, each of the known hash values is associated with one or more vector embeddings previously generated or otherwise output by the data processing pipeline 200. In some implementations, the change detection component 260 may compare each of the hash values 240(1)-240(3) to the hash LUT 270 according to their hierarchical order. For example, the change detection component 260 may first compare the hash value 204 (1) to the hash LUT 270 to determine whether any changes have been made to the data asset 201. If the hash value 204 (1) matches a known hash value in the LUT 270, the change detection component 260 may output data reuse information 205 indicating that embeddings can be reused for each of the data chunks 203 associated with the data asset 201. In other words, the data processing pipeline 200 does not need to generate any new embeddings for the current data asset 201.

If the hash value 204 (1) does not match any known hash values in the LUT 270, the change detection component 260 may compare each of the hash value 204(2) to the LUT 270 to determine which of the semantic cells 202 have changed. If the hash value 204(2) for a given semantic cell 202 matches a known hash value in the LUT 270, the change detection component 260 may output data reuse information 205 indicating that embeddings can be reused for each of the data chunks 203 within the given semantic cell 202. In other words, the data processing pipeline 200 does not need to generate any new embeddings for the given semantic cell 202. However, if the hash value 204(2) for a given semantic cell 202 does not match any known hash values in the LUT 270, the change detection component 260 may compare a subset of the hash values 204(3) to the LUT 270 to determine which of the data chunks 203 within the given semantic cell 202 have changed. If the hash value for a given data chunk 203 matches a known hash value in the LUT 270, the change detection component 260 may output data reuse information 205 indicating that an embedding can be reused for the given data chunk 203. Otherwise, the change detection component 260 may output data reuse information 205 indicating that a new embedding must be generated for the given data chunk 204.

The chunk filter 230 is configured to selectively output data chunks 203, as filtered chunks 206, to the vector mapping component 240 based on the data reuse information 205. More specifically, the filtered chunks 206 may include only such data chunks 203 for which new embeddings must be generated (such as indicated by the data reuse information 205). The vector mapping component 240 is configured to map each of the filtered chunks 206 to a new embedding 207 (1). In some implementations, the vector mapping component 240 may perform the mapping based, at least in part, on a neural network model 208. For example, the filtered chunks 206 may be passed or otherwise processed through one or more embeddings layers of the neural network model 208 having outputs that result in the embeddings 207 (1). In some implementations, the new embeddings 207 (1) may be stored in a vector repository 290. More specifically, the vector repository 290 may store or index the new embeddings 207 (1) in connection with the data chunks 203 to which they are mapped. This allows the embeddings 207 (1) to be reused when processing subsequent updates or revisions to the data asset 201.

In some implementations, the vector retrieval component 280 may retrieve and/or output one or more existing embeddings 207(2) from the vector repository 290 based on the data reuse information 205. More specifically, the vector retrieval component 280 may match such data chunks 203 for which embeddings can be reused to existing embeddings stored in the vector repository 290. Aspects of the present disclosure recognize that retrieving existing embeddings 207(2) from a vector repository 290 requires considerably less overhead (including processing and/or memory resources) than generating new embeddings 207 (1) based on a neural network model 208. Thus, reusing existing embeddings 207(2) allows the data processing pipeline 200 to quickly process updates or revisions for a previously processed data asset 201. Among other advantages, the data processing pipeline 200 of the present disclosure enables fine-grained detection of changes to the data asset 201, optimized use of processing and/or memory resources (which results in materially lower costs, reduced storage capacity requirements, and reduced processing times), and significantly faster time to value.

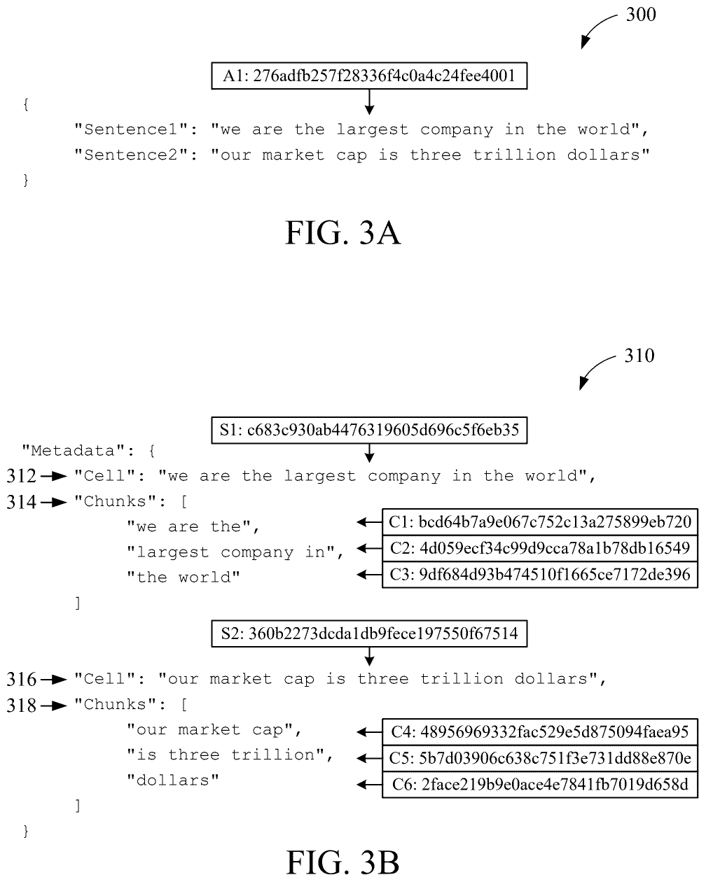

FIG. 3A shows an example data asset 300. In the example of FIG. 3A, the data asset 300 is depicted as a JavaScript Object Notation (JSON) file. More specifically, the data asset 300 includes the text (or token) stream: “Sentence 1 we are the largest company in the world Sentence 2 our market cap is three trillion dollars.” In some aspects, the data asset 300 may be processed or otherwise mapped to one or more vector embeddings (not shown for simplicity) by a data processing pipeline. With reference to FIGS. 1 and 2, the data asset 300 may be one example of any of the data assets 102 and/or 201 and the data processing pipeline may be one example of any of the data processing pipelines 120 and/or 200. In some implementations, the data processing pipeline may map the data asset 300 to a hash value (A1) for purposes of detecting changes or updates to the data asset 300 (such as described with reference to FIGS. 1 and 2). With reference to FIG. 2, the hash value A1 may be one example of the hash value 204 (1) associated with the data asset 201. As shown in FIG. 3A, the hash value A1 is an MD5 hash value equal to “276adfb257f28336f4c0a4c24fee4001.”

FIG. 3B shows example metadata 310 that can be extracted from the data asset 300 of FIG. 3A, according to some implementations. In some implementations, the metadata 310 may be extracted by a data processing pipeline (such as any of the data processing pipelines 120 or 200 of FIGS. 1 and 2, respectively). More specifically, the metadata 310 may be extracted by the semantic cell extraction component 210 and the chunking component 220 of FIG. 2. As shown in FIG. 3B, the metadata 310 includes multiple semantic cells 312 and 316 that are further subdivided into data chunks 314 and 318, respectively. With reference to FIG. 2, each of the semantic cells 312 and 316 may be one example of the semantic cells 202 and each of the data chunks 314 and 318 may be one example of the data chunk 203. In the example of FIG. 3B, each of the semantic cells 312 and 316 represents a respective sentence in the content item 300 and each data chunk represents a grouping of up to 3 consecutive words (or tokens) within a given semantic cell.

In some implementations, the data processing pipeline may map the metadata 310 to a set of hash values for purposes of detecting granular changes to the data asset 300 (such as described with reference to FIGS. 1 and 2). More specifically, the data processing pipeline may map each of the semantic cells 312 and 316 to respective hash values (S1 and S2) and may further map each of the data chunks 314 and 318 to respective hash values (C1-C3 and C4 C6). With reference to FIG. 2, the hash values S1 and S2 may be examples of the hash values 204(2) associated with the semantic cells 202, and the hash values C1-C6 may be examples of the hash values 204(3) associated with the data chunks 203. In the example of FIG. 3B, each of the hash values S1, S2 and C1-C6 is associated with an MD5 hash function having the following values:

S1 = “c683c930ab4476319605d696c5f6eb35”
C1 = “bcd64b7a9e067c752c13a275899eb720”
C2 = “4d059ecf34c99d9cca78a1b78db16549”
C3 = “9df684d93b474510f1665ce7172de396”
S2 = “360b2273dcda1db9fece197550f67514”
C4 = “48956969332fac529e5d875094faea95”
C5 = “5b7d03906c638c751f3e731dd88e870e”
C6 = “2face219b9e0ace4e7841fb7019d658d”

In some implementations, the data processing pipeline mare compare the hash values A1, S1, S2, and C1-C6 against a lookup table of known hash values (such as the hash LUT 270 of FIG. 2) to detect changes or updates to the data asset 300 at different levels of granularity. For example, the data processing pipeline may use the hash values A1, S1, S2, and/or C1-C6 to quickly determine whether the data asset 300, or any of the semantic cells 312 and 316 and/or data chunks 314 and 318, has been previously mapped to embeddings that can be reused by the data processing pipeline in lieu of generating new embeddings for such data. In some aspects, the hash values A1, S1, S2, and C1-C6 may be further stored in the lookup table for purposes of detecting subsequent changes or updates to the data asset 300.

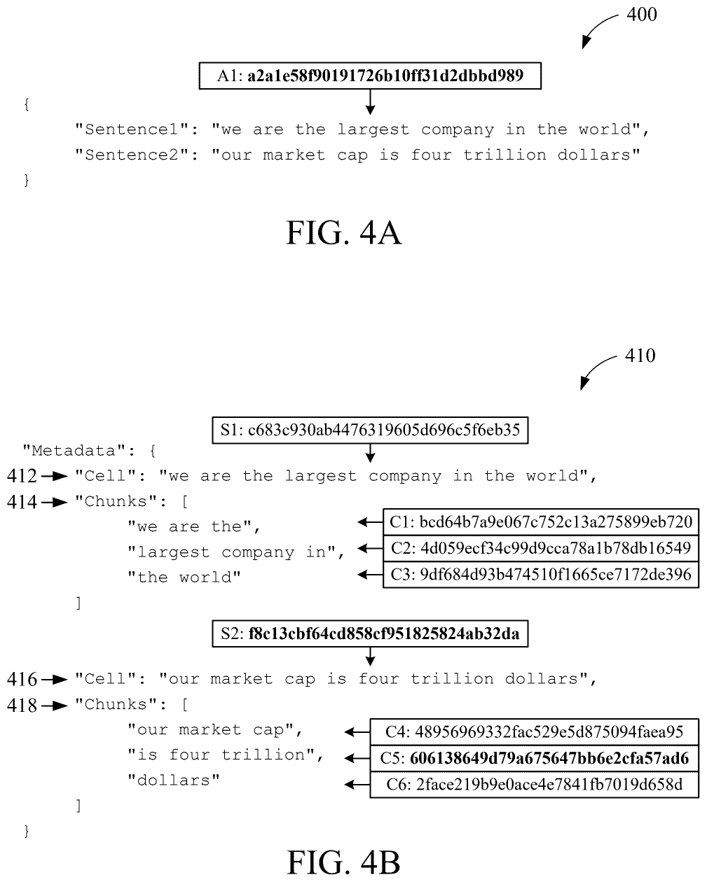

FIG. 4A shows another example data asset 400. In the example of FIG. 4A, the data asset 400 is depicted as a JSON file. More specifically, the data asset 400 includes the text (or token) stream: “Sentence 1 we are the largest company in the world Sentence 2 our market cap is four trillion dollars.” In some aspects, the data asset 400 may be processed or otherwise mapped to one or more vector embeddings (not shown for simplicity) by a data processing pipeline after processing the data asset 300 of FIG. 3A. With reference to FIGS. 1 and 2, the data asset 400 may be one example of any of the data assets 102 and/or 201 and the data processing pipeline may be one example of any of the data processing pipelines 120 and/or 200. In some implementations, the data processing pipeline may map the data asset 400 to a hash value (A1) for purposes of detecting changes or updates to the data asset 400 (such as described with reference to FIGS. 1 and 2). As shown in FIG. 4A, the hash value A1 is an MD5 hash value equal to “a2ale58f90191726b10ff31d2dbbd989.”

FIG. 4B shows example metadata 410 that can be extracted from the data asset 400 of FIG. 4A, according to some implementations. In some implementations, the metadata 410 may be extracted by a data processing pipeline (such as any of the data processing pipelines 120 or 200 of FIGS. 1 and 2, respectively). More specifically, the metadata 410 may be extracted by the semantic cell extraction component 210 and the chunking component 220 of FIG. 2. As shown in FIG. 4B, the metadata 410 includes multiple semantic cells 412 and 416 that are further subdivided into data chunks 414 and 418, respectively. With reference to FIG. 2, each of the semantic cells 412 and 416 may be one example of the semantic cells 202 and each of the data chunks 414 and 418 may be one example of the data chunk 203. In the example of FIG. 4B, each of the semantic cells 412 and 416 represents a respective sentence in the content item 300 and each data chunk represents a grouping of up to 3 consecutive words (or tokens) within a given semantic cell.

In some implementations, the data processing pipeline may map the metadata 410 to a set of hash values for purposes of detecting granular changes to the data asset 400 (such as described with reference to FIGS. 1 and 2). More specifically, the data processing pipeline may map each of the semantic cells 412 and 416 to respective hash values (S1 and S2) and may further map each of the data chunks 414 and 418 to respective hash values (C1-C3 and C4-C6). In the example of FIG. 4B, each of the hash values S1, S2 and C1-C6 is associated with an MD5 hash function having the following values:

S1 = “c683c930ab4476319605d696c5f6eb35”
C1 = “bcd64b7a9e067c752c13a275899eb720”
C2 = “4d059ecf34c99d9cca78a1b78db16549”
C3 = “9df684d93b474510f1665ce7172de396”
S2 = “f8c13cbf64cd858cf951825824ab32da”
C4 = “48956969332fac529e5d875094faea95”
C5 = “606138649d79a675647bb6e2cfa57ad6”
C6 = “2face219b9e0ace4e7841fb7019d658d”

In some implementations, the data processing pipeline may compare the hash values A1, S1, S2, and C1-C6 associated with the metadata 410 against a lookup table of known hash values, which includes the hash values A1, S1, S2, and C1-C6 associated with the metadata 310, to detect changes or updates to the data asset 400 at different levels of granularity. More specifically, the data processing pipeline may analyze each of the hash values A1, S1, S2, and C1-C6 associated with the metadata 410, in hierarchical order, beginning with the hash value A1 representing the data asset 400 as a whole. For example, the data processing pipeline may first determine that the hash value A1 does not match any known hash values stored in the lookup table. Accordingly, the data processing pipeline may proceed to analyze the hash values S1 and S2 representing the semantic cells 412 and 416.

As shown in FIG. 4B, the data processing pipeline may determine that the hash value S1 representing the semantic cell 412 matches the hash value S1 representing the semantic cell 312. Accordingly, the data processing pipeline may reuse any embeddings mapped to the semantic cell 312 as corresponding embeddings for the semantic cell 412 (such as embeddings generated for the data chunks: “we are the,” “largest company in,” and “the world”). In some implementations, the data processing pipeline may retrieve such embeddings from a vector repository (such as the vector repository 290 of FIG. 2). Because a match is detected at the semantic cell level, the data processing pipeline does not need to analyze any of the hash values C1-C3 associated with the data chunks 414 for matches in the lookup table.

The data processing pipeline may further determine that the hash value S2 representing the semantic cell 416 does not match any known hash values stored in the lookup table. Accordingly, the data processing pipeline may proceed to analyze the hash values C4-C6 representing the data chunks 418 within the semantic cell 416. As shown in FIG. 4B, the data processing pipeline may determine that the hash values C4 and C6 associated with the metadata 410 match the hash values C4 and C6 associated with the metadata 310. Accordingly, the data processing pipeline may reuse existing embeddings that have already been mapped to the data chunks: “our market cap” and “dollars.” However, the data processing pipeline also may determine that the hash value C5 associated with the metadata 410 does not match any known hash values stored in the lookup table. Accordingly, the data processing pipeline may generate a new embedding for the data chunk: “is four trillion.”

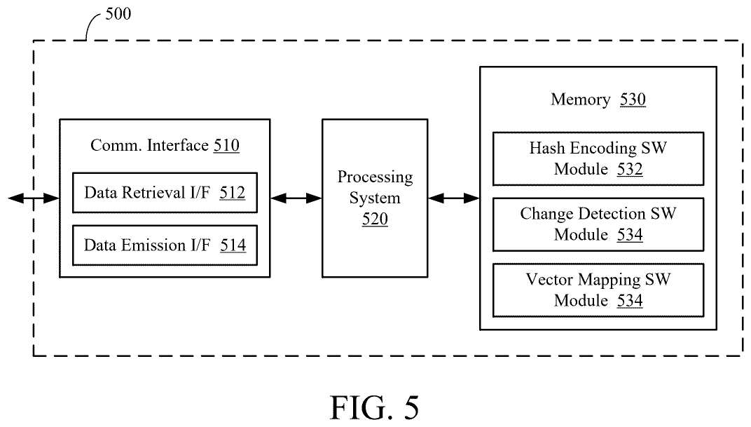

FIG. 5 shows a block diagram of an example data processing pipeline 500, according to some implementations. In some implementations, the data processing pipeline 500 may be one example of any of the data processing pipelines 120 or 200 of FIGS. 1 and 2, respectively. More specifically, the data processing pipeline 500 is configured to transform a data asset into a set of vector embeddings.

The processing pipeline 500 includes a communication interface 510, a processing system 520, and a memory 530. The communication interface 510 is configured to communicate with one or more data repositories. More specifically, the communication interface 510 includes a data retrieval interface (I/F) 512 for communicating with one or more input data repositories (such as the input data repositories 101 of FIG. 1) and a data emission interface (I/F) 514 for communicating with one or more output data repositories (such as the output data repositories 109 of FIG. 1). In some implementations, the data retrieval interface 512 may receive a data asset.

The memory 530 includes a non-transitory computer-readable medium (including one or more nonvolatile memory elements, such as EPROM, EEPROM, Flash memory, or a hard drive, among other examples) that can store the following software (SW) modules: a hash encoding SW module 532 to map the data asset to one or more hash values; a change detection SW module 534 to determine whether the one or more hash values match one or more known hash values stored in a lookup table; and a vector mapping SW module 536 to selectively map the data asset to one or more vector embeddings based on whether the one or more hash values match the one or more known hash values.

The processing system 520 includes any suitable one or more processors capable of executing scripts or instructions of one or more software programs stored in the data processing pipeline 500 (such as in the memory 530). For example, the processing system 520 can execute the hash encoding SW module 532 to map the data asset to one or more hash values. The processing system 520 can also execute the change detection SW module 534 to determine whether the one or more hash values match one or more known hash values stored in a lookup table. The processing system 520 can further execute the vector mapping SW module 536 to selectively map the data asset to one or more vector embeddings based on whether the one or more hash values match the one or more known hash values.

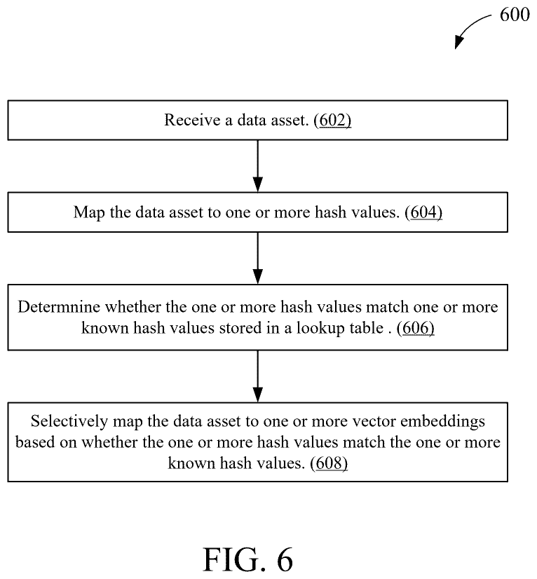

FIG. 6 shows an illustrative flowchart depicting an example operation 600 for processing data, according to some implementations. In some implementations, the example operation 600 may be performed by a data processing pipeline such as the data processing pipeline 500 of FIG. 5.

The data processing pipeline receives a data asset (602). The data processing pipeline maps the data asset to one or more hash values (604). In some implementations, the one or more hash values may be associated with previously generated vector embeddings stored in a vector repository. The data processing pipeline determines whether the one or more hash values match one or more known hash values stored in a lookup table (606). Further, the data processing pipeline selectively maps the data asset to one or more vector embeddings based on whether the one or more hash values match the one or more known hash values (608). In some implementations, the one or more vector embeddings may be associated with a neural network model.

In some aspects, the mapping of the data asset to the one or more hash values may include mapping the data asset in its entirety to a first hash value of the one or more hash values. In some implementations, the selective mapping of the data asset to one or more vector embeddings may include refraining from mapping the data asset to any vector embeddings responsive to determining that the first hash value matches one of the one or more known hash values.

In some other aspects, the mapping of the data asset to the one or more hash values may include subdividing the data asset into a plurality of data segments and mapping the plurality of data segments to a plurality of hash values, respectively. In some implementations, the plurality of data segments may include a semantic cell. In such implementations, the selective mapping of the data asset to one or more vector embeddings may include refraining from mapping the semantic cell to any vector embeddings responsive to determining that the hash value mapped to the semantic cell matches one of the one or more known hash values.

In some other implementations, the plurality of data segments may further include a chunk of the semantic cell. In such implementations, the selective mapping of the data asset to one or more vector embeddings may include mapping the chunk to a respective embedding vector responsive to determining that the hash value mapped to the chunk does not match any of the one or more known hash values. In some implementations, the data processing pipeline may further update the lookup table to include the hash value mapped to the chunk.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for processing data, comprising:
receiving a data asset;
mapping the data asset to one or more hash values;
determining whether the one or more hash values match one or more known hash values stored in a lookup table; and
selectively mapping the data asset to one or more vector embeddings based on whether the one or more hash values match the one or more known hash values.

2. The method of claim 1, wherein the one or more known hash values are associated with previously generated vector embeddings stored in a vector repository.

3. The method of claim 1, wherein the one or more vector embeddings are associated with a neural network model.

4. The method of claim 1, wherein the mapping of the data asset to the one or more hash values comprises:
mapping the data asset in its entirety to a first hash value of the one or more hash values.

5. The method of claim 4, wherein the selective mapping of the data asset to one or more vector embeddings comprises:
refraining from mapping the data asset to any vector embeddings responsive to determining that the first hash value matches one of the one or more known hash values.

6. The method of claim 1, wherein the mapping of the data asset to the one or more hash values comprises:
subdividing the data asset into a plurality of data segments; and
mapping the plurality of data segments to a plurality of hash values, respectively.

7. The method of claim 6, wherein the plurality of data segments includes a semantic cell.

8. The method of claim 7, wherein the selective mapping of the data asset to one or more vector embeddings comprises:
refraining from mapping the semantic cell to any vector embeddings responsive to determining that the hash value mapped to the semantic cell matches one of the one or more known hash values.

9. The method of claim 7, wherein the plurality of data segments further includes a chunk of the semantic cell.

10. The method of claim 9, wherein the selective mapping of the data asset to one or more vector embeddings comprises:
mapping the chunk to a respective embedding vector responsive to determining that the hash value mapped to the chunk does not match any of the one or more known hash values.

11. The method of claim 10, further comprising:
updating the lookup table to include the hash value mapped to the chunk.

12. A data processing pipeline comprising:
a processing system; and
a memory storing instructions that, when executed by the processing system, causes the data processing pipeline to:
receive a data asset;
map the data asset to one or more hash values;
determine whether the one or more hash values match one or more known hash values stored in a lookup table; and
selectively map the data asset to one or more vector embeddings based on whether the one or more hash values match the one or more known hash values.

13. The data processing pipeline of claim 12, wherein the one or more known hash values are associated with previously generated vector embeddings stored in a vector repository.

14. The data processing pipeline of claim 12, wherein the one or more vector embeddings are associated with a neural network model.

15. The data processing pipeline of claim 12, wherein the mapping of the data asset to the one or more hash values comprises:
mapping the data asset in its entirety to a first hash value of the one or more hash values.

16. The data processing pipeline of claim 15, wherein the selective mapping of the data asset to one or more vector embeddings comprises:
refraining from mapping the data asset to any vector embeddings responsive to determining that the first hash value matches one of the one or more known hash values.

17. The data processing pipeline of claim 12, wherein the mapping of the data asset to the one or more hash values comprises:
subdividing the data asset into a plurality of data segments; and
mapping the plurality of data segments to a plurality of hash values, respectively.

18. The data processing pipeline of claim 17, wherein the plurality of data segments includes a semantic cell or a chunk thereof.

19. The data processing pipeline of claim 18, wherein the selective mapping of the data asset to one or more vector embeddings comprises:
refraining from mapping the semantic cell to any vector embeddings responsive to determining that the hash value mapped to the semantic cell or chunk thereof matches one of the one or more known hash values.

20. The data processing pipeline of claim 19, wherein execution of the instructions further causes the data processing pipeline to:
update the lookup table to include the hash value mapped to the chunk.
